(19) United States
(12) Patent Application Publication
(10) Pub. No.: US 2024/0170735 A1
(43) Pub. Date: May 23, 2024

(54) FLAME RETARDANTS FOR BATTERY ELECTROLYTES

(71) Applicant: Albemarle Corporation, Charlotte, NC (US)

(72) Inventor: Charles Daniel Varnado, Jr., Baton Rouge, LA (US)

(21) Appl. No.: 18/283,995

(22) PCT Filed: Mar. 31, 2022
(86) PCT No.: PCT/US2022/022732

§ 371 Date: Sep. 25, 2023

Related U.S. Application Data
(60) Provisional application No. 63/169,426, filed on Apr. 1, 2021.

(51) Int. Cl. H01M 10/42; H01M 10/052; H01M 10/0567; H01M 10/0569

(52) U.S. Cl. CPC H01M 10/4235; H01M 10/052; H01M 10/0567; H01M 10/0569

(57) ABSTRACT

This invention provides nonaqueous electrolyte solutions for lithium batteries. The nonaqueous electrolyte solutions comprise a liquid electrolyte medium; a lithium-containing salt; and at least one brominated flame retardant.

### TECHNICAL FIELD

This invention relates to brominated flame retardants for electrolyte solutions for batteries.

### BACKGROUND

One of the components impacting the safety of lithium-ion batteries is their use of flammable solvents in the lithium-containing electrolyte solutions. Inclusion of a flame retardant in the electrolyte solution is one way to mitigate the flammability of these solutions. For a flame retardant to be a suitable component of an electrolyte solution, solubility in the electrolyte is needed, along with electrochemical stability over the range of battery operation, and minimal negative effect on battery performance. Negative effects on battery performance can include reduced conductivity chemical instability to the active material, consumption of lithium, and/or formation of resistive interfaces on the active materials, which can have a deleterious impact on solid electrolyte interface (SEI) formation during initial cycling, resulting in chemical degradation of the electrolyte.

What is desired is a flame retardant that can effectively suppress the flammability of lithium ion batteries with minimal impact to the electrochemical performance of the lithium ion battery at a reasonable cost.

### SUMMARY OF THE INVENTION

This invention provides nonaqueous electrolyte solutions for lithium batteries which contain at least one brominated flame retardant. In the presence of the brominated flame retardant(s), fires are extinguished in these nonaqueous electrolyte solutions, at least under laboratory conditions.

An embodiment of this invention is a nonaqueous electrolyte solution for a lithium battery, which solution comprises i) a liquid electrolyte medium; ii) a lithium-containing salt; and iii) at least one brominated flame retardant. The brominated flame retardant is selected from a) a brominated thiophene having two or more bromine atoms bound to the same thiophene ring, b) a brominated thiazole having one or two bromine atoms bound to the thiazole ring, wherein when the brominated thiazole has two bromine atoms bound to the thiazole ring and the bromine atoms are in the 2 and 5 positions on the ring, a carbon atom of the thiazole ring has an oxygen-containing substituent bound thereto, and c) a brominated thiadiazole having one bromine atom bound to the thiadiazole ring and an oxygen-containing group bound to a carbon atom of the thiadiazole ring.

Another embodiment of this invention is a nonaqueous electrolyte solution for a lithium battery, which solution comprises i) a liquid electrolyte medium; ii) a lithium-containing salt; and iii) at least one brominated flame retardant. The brominated flame retardant is selected from the group consisting of 2,3-dibromothiophene, 2,4-dibromothiophene, 2,5-dibromothiophene, 3,4-dibromothiophene, 2,3,4-tribromothiophene, 2,3,5-tribromothiophene, propyl 1,1-dimethyl-2-[4-(2,3,5-tribromothiophene)]ethyl ether, ethyl 4-(2,3,5-tribromothiophene) carbonate, methyl 1,1-dimethyl-2-[4-(2,3,5-tribromothiophene)]ethyl carbonate, methyl 2,5-dibromothiophene-3-carboxylate, ethyl 2,5-dibromothiophene-3-carboxylate, methyl 4,5-dibromothiophene-2-carboxylate, ethyl 4,5-dibromothiophene-2-carboxylate, ethyl 4,5-dibromothiophene-3-carboxylate, dimethyl 3,4-dibromothiophene-2,5-dicarboxylate, diethyl 3,4-dibromothiophene-2,5-dicarboxylate, 2-bromothiazole, 4-bromothiazole, 5-bromothiazole, 2,4-dibromothiazole, 4,5-dibromothiazole, 4,5-dibromo-2-methoxythiazole, 4,5-dibromo-2-(2-methoxyethoxy)thiazole, 2-bromo-5-methoxy-1,3,4-thiadiazole, 2-bromo-5-(2-methoxyethoxy)-1,3,4-thiadiazole, and 2-bromo-5-(2-ethoxyethoxy)-1,3,4-thiadiazole.

These and other embodiments and features of this invention will be still further apparent from the ensuing description and appended claims.

### FURTHER DETAILED DESCRIPTION OF THE INVENTION

Throughout this document, the phrase “electrolyte solution” is used interchangeably with the phrase “nonaqueous electrolyte solution”.

The liquid electrolyte medium is comprised of one or more solvents that typically form the liquid electrolyte medium for lithium electrolyte solutions used in lithium batteries, which solvents are polar and aprotic, stable to electrochemical cycling, and preferably have low viscosity. These solvents usually include noncyclic carbonic acid esters, cyclic carbonic acid esters, ethers, sulfur-containing compounds, and esters of boric acid.

The solvents that can form the liquid electrolyte medium in the practice of this invention include ethylene carbonate (1,3-dioxolan-2-one), dimethyl carbonate, ethyl methyl carbonate, diethyl carbonate, dioxolane, dimethoxy ethane (glyme), tetrahydrofuran, ethylene sulfite, 1,3-propylene glycol boric ester, bis(2,2,2-trifluoroethyl)ether, and mixtures of any two or more of the foregoing.

Preferred solvents include ethylene carbonate, ethyl methyl carbonate, and mixtures thereof. More preferred are mixtures of ethylene carbonate and ethyl methyl carbonate, especially at volume ratios of ethylene carbonate:ethyl methyl carbonate ratios of about 20:80 to about 40:60, more preferably about 25:75 to about 35:65.

Suitable lithium-containing salts in the practice of this invention include lithium perchlorate, lithium nitrate, lithium thiocyanate, lithium aluminate, lithium tetrachloroaluminate, lithium tetrafluoroaluminate, lithium tetraphenylborate, lithium tetrafluoroborate, lithium bis(oxolato)borate (LiBOB), lithium di(fluoro)(oxalato)borate, lithium hexafluorophosphate, lithium hexafluoroarsenate, lithium hexafluoroantimonate, lithium titanium oxide, lithium manganese oxide, lithium cobalt oxide (LiCoO₂), lithium nickel oxide (LiNiO₂), lithium alkyl carbonates in which the alkyl group has 1 to 6 carbon atoms, lithium methylsulfonate, lithium trifluoromethylsulfonate, lithium pentafluoroethylsulfonate, lithium pentafluorophenylsulfonate, lithium fluorosulfonate, lithium bis(trifluoromethylsulfonyl)imide, lithium bis(pentafluoroethylsulfonyl)imide, lithium (ethylsulfonyl)(trifluoromethylsulfonyl)imide, and mixtures of any two or more of the foregoing. Preferred lithium-containing salts include lithium hexafluorophosphate, lithium tetrafluoroborate, lithium di(fluoro)(oxolato)borate, and lithium bis(oxolato)borate.

Typical concentrations for the lithium-containing salt in the electrolyte solution are in the range of about 0.1 M to about 2.5 M, preferably about 0.5 M to about 2 M, more preferably about 0.75 M to about 1.75 M, and still more preferably about 0.95 M to about 1.5 M. When more than one lithium-containing salt forms the lithium-containing electrolyte, the concentration refers to the total concentration of all of the lithium-containing salts present in the electrolyte solution.

The electrolyte solution can contain other salts in addition to lithium salts, unless such other salt(s) materially degrade either the performance of the battery for the desired application, or the flame retardancy of the electrolyte solution. Suitable electrolytes other than lithium salts include other alkali metal salts, e.g., sodium salts, potassium salts, rubidium salts, and cesium salts, and alkaline earth metal salts, e.g., magnesium salts, calcium salts, strontium salts, and barium salts. In some aspects, the salts in the non-aqueous electrolyte solution are only one or more lithium salts.

Suitable alkali metal salts that can be present in the electrolyte solution include sodium salts such as sodium chloride, sodium bromide, sodium iodide, sodium perchlorate, sodium nitrate, sodium thiocyanate, sodium aluminate, sodium tetrachloroaluminate, sodium tetrafluoroaluminate, sodium tetraphenylborate, sodium tetrafluoroborate, and sodium hexafluorophosphate; and potassium salts such as potassium chloride, potassium bromide, potassium iodide, potassium perchlorate, potassium nitrate, potassium thiocyanate, potassium aluminate, potassium tetrachloroaluminate, potassium tetrafluoroaluminate, potassium tetraphenylborate, potassium tetrafluoroborate, and potassium hexafluorophosphate.

Suitable alkaline earth metal salts that can be present in the electrolyte solution include magnesium salts such as magnesium chloride, magnesium bromide, magnesium iodide, magnesium perchlorate, magnesium nitrate, magnesium thiocyanate, magnesium aluminate, magnesium tetrachloroaluminate, magnesium tetrafluoroaluminate, magnesium tetraphenylborate, magnesium tetrafluoroborate, and magnesium hexafluorophosphate; and calcium salts such as calcium chloride, calcium bromide, calcium iodide, calcium perchlorate, calcium nitrate, calcium thiocyanate, calcium aluminate, calcium tetrachloroaluminate, calcium tetrafluoroaluminate, calcium tetraphenylborate, calcium tetrafluoroborate, and calcium hexafluorophosphate.

In the practice of this invention, liquid brominated flame retardants are miscible with the liquid medium of the nonaqueous electrolyte solution, where “miscible” means that the brominated flame retardant does not form a separate phase from the electrolyte solution. More specifically, a brominated flame retardant is miscible if it forms a single phase in a mixture of 30 wt % ethylene carbonate and 70 wt % ethyl methyl carbonate which contains 1.2 M lithium hexafluorophosphate, after stirring overnight with a magnetic stirrer to dissolve solid compounds, and no separate phase is formed after the stirring is stopped, and the brominated flame retardant does not precipitate from, or form a suspension or slurry in, the nonaqueous electrolyte solution. It is recommended and preferred that the brominated flame retardant does not cause the precipitation of, or formation of a suspension or slurry of, any of the other components of the nonaqueous electrolyte solution.

In the practice of this invention, solid brominated flame retardants are soluble in the liquid medium of the nonaqueous electrolyte solution, where “soluble” means that the brominated flame retardant does not precipitate from the electrolyte solution. More specifically, a brominated flame retardant is soluble if it forms a single phase in a mixture of 30 wt % ethylene carbonate and 70 wt % ethyl methyl carbonate which contains 1.2 M lithium hexafluorophosphate, after stirring overnight with a magnetic stirrer to dissolve solid compounds, and no separate phase or precipitate is formed after the stirring is stopped, and the brominated flame retardant does not precipitate from, or form a suspension or slurry in, the nonaqueous electrolyte solution. It is recommended and preferred that the brominated flame retardant does not cause the precipitation of, or formation of a suspension or slurry of, any of the other components of the nonaqueous electrolyte solution.

In the practice of this invention, the brominated flame retardants generally have a bromine content of about 30 wt % or more, based on the weight of the brominated flame retardant. The brominated flame retardants in the practice of this invention have a bromine content in the molecule that ranges from about 30 wt % to about 75 wt %.

The boiling point of the brominated flame retardants in this invention are usually about 75° C. or more, preferably about 95° C. or more. Generally, the brominated flame retardants used in the practice of this invention have boiling points near or above the boiling point of the solvent or solvent mixture of the nonaqueous electrolyte solution. The boiling points described throughout this document are at standard temperature and pressure (standard conditions) unless otherwise stated.

The brominated flame retardants used in the practice of this invention are generally polar and aprotic, stable to electrochemical cycling. Liquid brominated flame retardants preferably also have low viscosities.

In the practice of this invention, a flame retardant amount in the nonaqueous electrolyte solution means enough flame retardant is present that the solution passes the modified horizontal UL-94 test described below. The flame retardant amount is often different for different brominated flame retardants. For the brominated thiophenes, the flame retardant amount is usually about 10 wt % or more, preferably about 11 wt % or more, more preferably about 12 wt % or more, of bromine in solution, relative to the total weight of the nonaqueous electrolyte solution. For the brominated thiazoles, the flame retardant amount is usually about 12 wt % or more of bromine in solution, relative to the total weight of the nonaqueous electrolyte solution. For the brominated thiadiazoles, the flame retardant amount is usually about 11 wt % or more, preferably about 12 wt % or more of bromine in solution, relative to the total weight of the nonaqueous electrolyte solution.

The brominated flame retardants of this invention share some overall characteristics. All have an unsaturated 5-membered ring containing sulfur; some of these flame retardants have one or two nitrogen atoms in the ring. In these brominated flame retardants, the bromine atoms are bound to carbon atoms of the ring.

In some embodiments, the brominated flame retardant is a brominated thiophene comprising two or more bromine atoms bound to the same thiophene ring; there is no heteroatom in the thiophene ring other than the sulfur atom. Thiophenes containing one bromine atom in the ring do not perform well as flame retardants in the nonaqueous electrolyte solutions. Typically, the brominated thiophenes used in this invention have four to about twelve carbon atoms, preferably four to about ten carbon atoms, in the molecule. There are two or three bromine atoms bound to the same thiophene ring, and/or a bromine content preferably about 40 wt % or more, more preferably about 40 wt % to about 75 wt %, relative to the total weight of the brominated flame retardant.

In some embodiments in which the brominated flame retardant is a brominated thiophene, there are one or two substituents on the thiophene ring in addition to the bromine atoms. These other substituents are usually oxygen-containing groups, typically ether groups, ester groups, or carbonate groups, and these brominated thiophenes have about six to about twelve carbon atoms, preferably six to about ten carbon atoms, in the molecule.

In embodiments in which the brominated thiophene contains an ether group as a substituent on the thiophene ring, the ether oxygen atom is not bound directly to the thiophene ring. It has been found that ether groups in which the oxygen atom is bound to a carbon atom of the thiophene ring (e.g., an alkoxy group) react with the electrolyte. The portion of the ether group between the thiophene ring and the ether oxygen atom is normally a saturated hydrocarbylene group having one to about four carbon atoms, and the other group attached to the ether oxygen atom is normally a saturated hydrocarbyl group having one to about four carbon atoms, preferably one to about three carbon atoms, and is methyl, ethyl, n-propyl, 2-propyl, n-butyl, sec-butyl, or iso-butyl, preferably methyl or ethyl. The hydrocarbylene group is a straight chain or is branched, and may be ethylene, propylene, or butylene. In this invention, preferred brominated thiophenes that are ethers include propyl 1,1-dimethyl-2-[4-(2,3,5-tribromothiophene)]ethyl ether, also called n-propyl 1,1-dimethyl-2-(2,4,5-tribromothiophen-3-yl)-ethyl ether.

In embodiments in which the brominated thiophene contains an ester group as a substituent on the thiophene ring, the carbonyl moiety of the ester group is bound directly to the thiophene ring, and the other portion of the ester group is usually a hydrocarbyl group having one to about four carbon atoms, preferably one to about three carbon atoms, and is methyl, ethyl, n-propyl, 2-propyl, n-butyl, sec-butyl, or iso-butyl, preferably methyl or ethyl, more preferably ethyl. Some of the brominated thiophenes contain two ester groups; the ester groups may be the same or different. In the ester-containing brominated thiophenes, there are usually two to about three bromine atoms, preferably two bromine atoms, bound to the thiophene ring. The bromine content of the ester-containing brominated thiophenes is preferably about 40 wt % or more, more preferably about 40 wt % to about 65 wt %, even more preferably about 40 wt % to about 60 wt %, relative to the total weight of the brominated flame retardant. Preferred brominated thiophenes in this invention that are esters include methyl 2,5-dibromothiophene-3-carboxylate, also called methyl (2,5-dibromothiophen-3-yl) carboxylate; ethyl 2,5-dibromothiophene-3-carboxylate; methyl 4,5-dibromothiophene-2-carboxylate, also called methyl 4,5-dibromothiophen-2-yl carboxylate; ethyl 4,5-dibromothiophene-2-carboxylate, also called ethyl 4,5-dibromothiophen-2-yl carboxylate; ethyl 4,5-dibromothiophene-3-carboxylate; dimethyl 3,4-dibromothiophene-2,5-dicarboxylate; and diethyl 3,4-dibromothiophene-2,5-dicarboxylate.

In embodiments in which the brominated thiophene contains a carbonate group as a substituent on the thiophene ring, an oxygen atom of the carbonate group can be bound directly to the thiophene ring, or not bound directly to the thiophene ring. The group attached to the other carbonate oxygen atom is usually either a hydrocarbyl group having one to about four carbon atoms, preferably one to about three carbon atoms, and is methyl, ethyl, n-propyl, 2-propyl, n-butyl, sec-butyl, or iso-butyl, preferably methyl or ethyl, or an ether group having three to about six carbon atoms, and one to three oxygen atoms, and preferably is 2-methoxyethoxy or 2-ethoxyethoxy. When the carbonate group is not bound to the thiophene ring via an oxygen atom of the carbonate group, the portion of the carbonate group between the thiophene ring and the carbonate oxygen atom is normally a saturated hydrocarbylene group having one to about four carbon atoms. The hydrocarbylene group is a straight chain or branched, and preferably is ethylene, propylene, or butylene. In the carbonate-containing brominated thiophenes, there are usually two to about three bromine atoms, preferably three bromine atoms, bound to the thiophene ring. The bromine content of the ester-containing brominated thiophenes is preferably about 45 wt % or more, more preferably about 45 wt % to about 65 wt %, even more preferably about 45 wt % to about 60 wt %, relative to the total weight of the brominated flame retardant. Preferred brominated flame retardants in this invention that are carbonates include ethyl 4-(2,3,5-tribromothiophene) carbonate, also called ethyl (2,4,5-tribromothiophen-3-yl) carbonate, and methyl 1,1-dimethyl-2-[4-(2,3,5-tribromothiophene)]ethyl carbonate, also called methyl 1,1-dimethyl-2-(2,4,5-tribromothiophen-3-yl)-ethyl carbonate.

In the brominated thiophene, when there are two bromine atoms, they are preferably in the 2-position and 5-position on the thiophene ring. Other substituents on the thiophene ring, when present, are preferably in the 3-position when there is one substituent, and preferably in the 3-position and 4-position when there are two substituents.

Preferably, the brominated thiophene is 2,3-dibromothiophene, 2,4-dibromothiophene, 2,5-dibromothiophene, 3,4-dibromothiophene, 2,3,4-tribromothiophene, 2,3,5-tribromothiophene, propyl 1,1-dimethyl-2-[4-(2,3,5-tribromothiophene)]ethyl ether, ethyl 4-(2,3,5-tribromothiophene) carbonate, methyl 1,1-dimethyl-2-[4-(2,3,5-tribromothiophene)]ethyl carbonate, methyl 2,5-dibromothiophene-3-carboxylate, ethyl 2,5-dibromothiophene-3-carboxylate, methyl 4,5-dibromothiophene-2-carboxylate, ethyl 4,5-dibromothiophene-2-carboxylate, ethyl 4,5-dibromothiophene-3-carboxylate, dimethyl 3,4-dibromothiophene-2,5-dicarboxylate, and diethyl 3,4-dibromothiophene-2,5-dicarboxylate. More preferred brominated thiophenes include 2,3-dibromothiophene and 2,5-dibromothiophene, especially 2,3-dibromothiophene.

In another embodiment, the brominated flame retardant is a brominated thiazole comprising one or two bromine atoms bound to the thiazole ring; two bromine atoms on the ring are preferred. The thiazole can be a 1,2-thiazole or a 1,3-thiazole; preferably, the brominated thiazole is a 1,3-thiazole. When the brominated thiazole has one bromine atom bound to the thiazole ring, there are typically three to about twelve carbon atoms, preferably three to about ten carbon atoms, in the molecule. When the brominated thiazole has two bromine atoms bound to the thiazole ring, and the bromine atoms are in the 2 and 5 positions on the ring, a carbon atom of the thiazole ring has an oxygen-containing substituent bound thereto, and there are typically four to about twelve carbon atoms, preferably four to about ten carbon atoms, in the molecule. When the brominated thiazole has two bromine atoms bound to the thiazole ring, at the 2 and 4 positions on the ring or at the 4 and 5 positions on the ring, preferably a carbon atom of the thiazole ring has an oxygen-containing substituent bound thereto, and there are typically four to about twelve carbon atoms, preferably four to about ten carbon atoms, in the molecule.

Preferably, there are two bromine atoms bound to the thiazole ring, and/or a bromine content of about 30 wt % or more, preferably about 35 wt % or more, more preferably about 40 wt % or more, relative to the total weight of the brominated flame retardant. In these brominated thiazoles, the bromine content is often about 30 wt % to about 60 wt %, preferably about 35 wt % to about 60 wt %, more preferably about 40 wt % to about 60 wt %, relative to the total weight of the brominated flame retardant. Brominated thiazoles having one bromine atom bound to the thiazole ring preferably have at least one oxygen-containing substituent bound to a carbon atom on the ring in addition to the bromine atom. The oxygen-containing substituents on the carbon atoms of the thiazole ring are preferably hydrocarbyloxy and alkoxyether groups. The hydrocarbyloxy groups usually have one to about four carbon atoms, preferably one to about three carbon atoms, and may be methoxy, ethoxy, n-propoxy, 2-propoxy, n-butoxy, sec-butoxy, or iso-butoxy, preferably methoxy or ethoxy. The alkoxyether groups have three to about seven carbon atoms, and one to about four oxygen atoms, preferably one to about three carbon atoms, and preferably is 2-methoxyethoxy or 2-ethoxyethoxy.

Preferably, the brominated thiazole is 2-bromothiazole, 4-bromothiazole, 5-bromothiazole, 2,4-dibromothiazole, 4,5-dibromothiazole, 4,5-dibromo-2-methoxythiazole, or 4,5-dibromo-2-(2-methoxyethoxy)thiazole; more preferred are 2-bromothiazole, 4-bromothiazole, 5-bromothiazole, 4,5-dibromo-2-methoxythiazole, and 4,5-dibromo-2-(2-methoxyethoxy)thiazole.

In another embodiment, the brominated flame retardant is a brominated thiadiazole comprising one bromine atom bound to the thiadiazole ring and an oxygen-containing substituent bound to a carbon atom of the thiadiazole ring. The thiadiazole can be a 1,2,3,-thiadiazole or a 1,3,4-thiadiazole, and is preferably a 1,3,4,-thiadiazole. Typically, there are three to about twelve carbon atoms, preferably three to about ten carbon atoms, in the molecule. Preferably, the bromine content is about 22 wt % or more, more preferably about 30 wt % or more, even more preferably about 35 wt % or more, relative to the total weight of the brominated flame retardant. In these brominated thiadiazoles, the bromine content is often about 22 wt % to about 45 wt %, preferably about 30 wt % to about 45 wt %, relative to the total weight of the brominated flame retardant. The brominated thiadiazoles have an oxygen-containing substituent bound to a carbon atom on the ring, and the oxygen-containing substituents are usually hydrocarbyloxy or alkoxyether groups. The hydrocarbyloxy groups usually have one to about four carbon atoms, preferably one to about three carbon atoms, and may be methoxy, ethoxy, n-propoxy, 2-propoxy, n-butoxy, sec-butoxy, or iso-butoxy, preferably methoxy or ethoxy. The alkoxyether groups have three to about seven carbon atoms, and one to about four oxygen atoms, preferably one to about three carbon atoms, and preferably is 2-methoxyethoxy or 2-ethoxyethoxy.

Preferably, the brominated thiadiazole is 2-bromo-5-methoxy-1,3,4-thiadiazole, 2-bromo-5-(2-methoxyethoxy)-1,3,4-thiadiazole, or 2-bromo-5-(2-ethoxyethoxy)-1,3,4-thiadiazole.

In some preferred embodiments of the invention, the liquid electrolyte medium is ethylene carbonate, ethyl methyl carbonate, or a mixture thereof. More preferably, the lithium-containing salt is lithium hexafluorophosphate, lithium di(fluoro)(oxalato)borate, or lithium bis(oxalato)borate.

In some embodiments of the invention, at least one electrochemical additive is included in the nonaqueous electrolyte solution.

In the practice of this invention, the electrochemical additives are soluble in, or miscible with, the liquid medium of the nonaqueous electrolyte solution. Electrochemical additives that are in liquid form are miscible with the liquid medium of the nonaqueous electrolyte solution, where “miscible” means that the electrochemical additives do not form a separate phase from the electrolyte solution. More specifically, an electrochemical additive is miscible if it forms a single phase in a mixture of 30 wt % ethylene carbonate and 70 wt % ethyl methyl carbonate which contains 1.2 M lithium hexafluorophosphate, after stirring overnight with a magnetic stirrer to dissolve solid compounds, and no separate phase is formed after the stirring is stopped, and the electrochemical additive does not precipitate from, or form a suspension or slurry in, the nonaqueous electrolyte solution.

The term “soluble,” usually used for electrochemical additives in solid form, indicates that, once dissolved, the electrochemical additive does not precipitate from, or form a suspension or slurry in, the nonaqueous electrolyte solution. More specifically, an electrochemical additive is soluble if it dissolves in a mixture of 30 wt % ethylene carbonate and 70 wt % ethyl methyl carbonate which contains 1.2 M lithium hexafluorophosphate, after stirring overnight with a magnetic stirrer to dissolve solid compounds, and if no precipitate, suspension, or slurry or separate phase is formed after the stirring is stopped. It is recommended and preferred that the electrochemical additive does not cause the precipitation of, or formation of a suspension or slurry of, any of the other components of the nonaqueous electrolyte solution.

The brominated flame retardant, electrochemical additive, and mixtures thereof are generally stable to electrochemical cycling, and preferably have low viscosities and/or do not significantly increase the viscosity of the nonaqueous electrolyte solution.

In various embodiments, the electrochemical additive is selected from a) unsaturated cyclic carbonates containing three to about four carbon atoms, b) fluorine-containing saturated cyclic carbonates containing three to about four carbon atoms and one to about two fluorine atoms, c) tris(trihydrocarbylsilyl) phosphites containing three to about six carbon atoms, d) trihydrocarbyl phosphates containing three to about nine carbon atoms, e) cyclic sultones containing three to about four carbon atoms, f) saturated cyclic hydrocarbyl sulfites having a 5-membered ring and containing two to about four carbon atoms, g) saturated cyclic hydrocarbyl sulfates having a 5-membered ring and containing two to about four carbon atoms, h) cyclic dioxadithio polyoxide compounds having a 6-membered or 7-membered ring and containing two to about four carbon atoms, i) another lithium-containing salt, and j) mixtures of any two or more of the foregoing.

In some embodiments, the electrochemical additive is an unsaturated cyclic carbonate containing three to about six carbon atoms, preferably three to about four carbon atoms. Suitable unsaturated cyclic carbonates include vinylene carbonate (1,3-dioxol-2-one), 4-methyl-1,3-dioxol-2-one, and 4,5-dimethyl-1,3-dioxol-2-one; vinylene carbonate is a preferred unsaturated cyclic carbonate. The unsaturated cyclic carbonate is preferably in an amount of about 0.5 wt % to about 12 wt %, more preferably about 0.5 wt % to about 3 wt % or about 8 wt % to about 11 wt %, relative to the total weight of the nonaqueous electrolyte solution.

When the electrochemical additive is a fluorine-containing saturated cyclic carbonate containing three to about five carbon atoms, preferably three to about four carbon atoms, and one to about four fluorine atoms, preferably one to about two fluorine atoms, suitable fluorine-containing saturated cyclic carbonates include 4-fluoro-ethylene carbonate and 4,5-difluoro-ethylene carbonate. Preferably the fluorine-containing saturated cyclic carbonate is 4-fluoro-ethylene carbonate. The fluorine-containing saturated cyclic carbonate is preferably in an amount of about 0.5 wt % to about 8 wt %, more preferably about 1.5 wt % to about 5 wt %, relative to the total weight of the nonaqueous electrolyte solution.

The tris(trihydrocarbylsilyl) phosphite electrochemical additives contain three to about nine carbon atoms, preferably about three to about six carbon atoms; the trihydrocarbylsilyl groups may be the same or different. Suitable tris(trihydrocarbylsilyl) phosphites include tris(trimethylsilyl) phosphite, bis(trimethylsilyl)(triethylsilyl) phosphite, tris(triethylsilyl) phosphite, bis(trimethylsilyl)(triethylsilyl) phosphite, bis(trimethylsilyl)(tri-n-propylsilyl)phosphite, and tris(tri-n-propylsilyl) phosphite; tris(trimethylsilyl) phosphite is a preferred tris(trihydrocarbylsilyl) phosphite. The tris(trihydrocarbylsilyl) phosphite is preferably in an amount of about 0.1 wt % to about 5 wt %, more preferably about 0.15 wt % to about 4 wt %, even more preferably about 0.2 wt % to about 3 wt %, relative to the total weight of the nonaqueous electrolyte solution.

In some embodiments, the electrochemical additive is a trihydrocarbyl phosphate containing three to about twelve carbon atoms, preferably three to about nine carbon atoms. The hydrocarbyl groups can be saturated or unsaturated, and the hydrocarbyl groups in the trihydrocarbyl phosphate may be the same or different. Suitable trihydrocarbyl phosphates include trimethyl phosphate, triethyl phosphate, dimethyl ethyl phosphate, tri-n-propyl phosphate, triallyl phosphate, and trivinyl phosphate; triallyl phosphate is a preferred trihydrocarbyl phosphate. The trihydrocarbyl phosphate is usually in an amount of about 0.5 wt % to about 5 wt %, preferably about 1 wt % to about 5 wt %, more preferably about 2 wt % to about 4 wt %, relative to the total weight of the nonaqueous electrolyte solution.

When the electrochemical additive is a cyclic sultone containing three to about eight carbon atoms, preferably three to about four carbon atoms, suitable cyclic sultones include 1-propane-1,3-sultone (1,3-propane sultone), 1-propene-1,2-sultone (1,3-propene sultone), 1,3-butane sultone (5-methyl-1,2-oxathiolane 2,2-dioxide), 2,4-butane sultone (3-methyl-1,2-oxathiolane 2,2-dioxide), 1,4-butane sultone (1,2-oxathiane 2,2-dioxide), 2-hydroxy-alpha-toluenesulfonic acid sultone (3H-1,2-benzoxathiole 2,2-dioxide), and 1,8-naphthosultone; preferred cyclic sultones include 1-propane-1,3-sultone and 1-propene-1,3-sultone. The cyclic sultone is preferably in an amount of about 0.25 wt % to about 5 wt %, more preferably about 0.5 wt % to about 4 wt %, relative to the total weight of the nonaqueous electrolyte solution.

The saturated cyclic hydrocarbyl sulfite electrochemical additive contains two to about six carbon atoms, preferably two to about four carbon atoms, and has a 5-membered or 6-membered ring, preferably a 5-membered ring. One or more substituents can be present on the ring, such as methyl or ethyl groups, preferably one or more methyl groups, more preferably, no substituents are present on the ring. Suitable saturated cyclic hydrocarbyl sulfites include 1,3,2-dioxathiolane, 2-oxide (1,2-ethylene sulfite), 1,2-propanediol sulfite (1,2-propylene sulfite), 4,5-dimethyl-1,3,2-dioxathiolane 2-oxide, 1,3,2-dioxathiane 2-oxide, 4-methyl-1,3-dioxathiane, 2-oxide (1,3-butylene sulfite); preferred cyclic hydrocarbyl sulfites include 1,3,2-dioxathiolane, 2-oxide (1,2-ethylene sulfite). The cyclic hydrocarbyl sulfite is preferably in an amount of about 0.5 wt % to about 5 wt %, more preferably about 1 wt % to about 4 wt %, relative to the total weight of the nonaqueous electrolyte solution.

In some embodiments, the electrochemical additive is a saturated cyclic hydrocarbyl sulfate containing two to about six carbon atoms, preferably two to about four carbon atoms, and has a 5-membered or 6-membered ring, preferably a 5-membered ring. One or more substituents can be present on the ring, such as methyl or ethyl groups, preferably one or more methyl groups, more preferably, no substituents are present on the ring. Suitable saturated cyclic hydrocarbyl sulfates include 1,3,2-dioxathiolane 2,2-dioxide (1,2-ethylene sulfate), 1,3,2-dioxathiane 2,2-dioxide (1,3-propylene sulfate), 4-methyl-1,3,2-dioxathiane 2,2-dioxide (1,3-butylene sulfate), and 5,5-dimethyl-1,3,2-dioxathiane 2,2-dioxide. The saturated cyclic hydrocarbyl sulfate is preferably in an amount of about 0.25 wt % to about 5 wt %, more preferably about 1 wt % to about 4 wt %, relative to the total weight of the nonaqueous electrolyte solution.

When the electrochemical additive is a cyclic dioxadithio polyoxide compound, the cyclic dioxadithio polyoxide compound contains two to about six carbon atoms, preferably two to about four carbon atoms, and has 6-membered, 7-membered, or 8-membered ring. Preferably, the cyclic dioxadithio polyoxide compound contains two to about four carbon atoms, and has 6-membered or 7-membered ring. One or more substituents can be present on the ring, such as methyl or ethyl groups, preferably one or more methyl groups, more preferably, no substituents are present on the ring. Suitable cyclic dioxadithio polyoxide compounds include 1,5,2,4-dioxadithiane 2,2,4,4-tetroxide, 1,5,2,4-dioxadithiepane 2,2,4,4-tetraoxide (cyclodisone), 3-methyl-1,5,2,4-dioxadithiepane, 2,2,4,4-tetraoxide, and 1,5,2,4-dioxadithiocane, 2,2,4,4-tetraoxide; 1,5,2,4-dioxadithiane 2,2,4,4-tetroxide is preferred. The cyclic dioxadithio polyoxide compound is preferably in an amount of about 0.5 wt % to about 5 wt %, more preferably about 1 wt % to about 4 wt %, relative to the total weight of the nonaqueous electrolyte solution.

The phrases “another lithium-containing salt” and “other lithium containing salt” indicate that there are at least two lithium salts used in the preparation of the electrolyte solution. When the electrochemical additive is another lithium-containing salt, it is preferably in an amount of about 0.5 wt % to about 5 wt % relative to the total weight of the nonaqueous electrolyte solution. Suitable lithium-containing salts include all of the lithium-containing salts listed above; lithium di(fluoro)(oxolato)borate and lithium bis(oxolato)borate are preferred.

Mixtures of any two or more of the foregoing electrochemical additives can be used, including different electrochemical additives of the same type and/or electrochemical additives of different types. When mixtures of electrochemical additives are used, the combined amount of the electrochemical additives is about 0.25 wt % to about 5 wt % relative to the total weight of the nonaqueous electrolyte solution. Mixtures of an unsaturated cyclic carbonate and a saturated cyclic hydrocarbyl sulfite or mixtures of a cyclic sultone, a tris(trihydrocarbylsilyl) phosphite, and a cyclic dioxadithio polyoxide compound are preferred.

Additional ingredients that are often included in electrolyte solutions for lithium batteries can also be present in the electrolyte solutions of the present invention. Such additional ingredients include nitrile compounds such as succinonitrile and perfluoroalkyl nitriles, and silazane compounds such as hexamethyldisilazane. A preferred additional ingredient is a nitrile compound; succinonitrile is a preferred nitrile compound. Typically, the amount of an optional ingredient is in the range of about 1 wt % to about 5 wt %, preferably about 1 wt % to about 4 wt %, relative to the total weight of the nonaqueous electrolyte solution.

In some preferred embodiments, a nitrile compound and another lithium-containing salt are components of the electrolyte solution. Nitrile compounds and lithium-containing salts are as described above. Preferably, the nitrile compound is succinonitrile, and the other lithium-containing salt is preferably lithium di(fluoro)(oxalato)borate.

Another embodiment of this invention provides a process for producing a nonaqueous electrolyte solution for a lithium battery. The process comprises combining components comprising i) a liquid electrolyte medium; ii) a lithium-containing salt; and iii) at least one brominated flame retardant selected from a brominated thiophene, brominated thiazole, or brominated diathiazole. Optionally, the components further comprise iv) at least one electrochemical additive as described above. The brominated flame retardant is present in the electrolyte solution in a flame retardant amount. The ingredients can be combined in any order, although it is preferable to add all of the components to the liquid electrolyte medium. Optional ingredients are also preferably added to the liquid electrolyte medium. Features of, and preferences for, the liquid electrolyte medium, lithium-containing salt, brominated flame retardant(s), electrochemical additive(s), and amounts of each component, are as described above.

Still another embodiment of this invention provides a process for producing a nonaqueous electrolyte solution for a lithium battery. The process comprises combining components comprising i) a liquid electrolyte medium; ii) a lithium-containing salt; and iii) at least one brominated flame retardant. Optionally, the components further comprise iv) at least one electrochemical additive as described above. The brominated flame retardant is selected from the group consisting of 2,3-dibromothiophene, 2,4-dibromothiophene, 2,5-dibromothiophene, 3,4-dibromothiophene, 2,3,4-tribromothiophene, 2,3,5-tribromothiophene, propyl 1,1-dimethyl-2-[4-(2,3,5-tribromothiophene)]ethyl ether, ethyl 4-(2,3,5-tribromothiophene) carbonate, methyl 1,1-dimethyl-2-[4-(2,3,5-tribromothiophene)]ethyl carbonate, methyl 2,5-dibromothiophene-3-carboxylate, ethyl 2,5-dibromothiophene-3-carboxylate, methyl 4,5-dibromothiophene-2-carboxylate, ethyl 4,5-dibromothiophene-2-carboxylate, ethyl 4,5-dibromothiophene-3-carboxylate, dimethyl 3,4-dibromothiophene-2,5-dicarboxylate, diethyl 3,4-dibromothiophene-2,5-dicarboxylate, 2-bromothiazole, 4-bromothiazole, 5-bromothiazole, 2,4-dibromothiazole, 4,5-dibromothiazole, 4,5-dibromo-2-methoxythiazole, 4,5-dibromo-2-(2-methoxyethoxy)thiazole, 2-bromo-5-methoxy-1,3,4-thiadiazole, 2-bromo-5-(2-methoxyethoxy)-1,3,4-thiadiazole, and 2-bromo-5-(2-ethoxyethoxy)-1,3,4-thiadiazole. Preferences for the liquid electrolyte medium, lithium-containing salt, electrochemical additive(s), and amounts of each component, are as described above.

The nonaqueous electrolyte solutions of the present invention, which contain one or more brominated flame retardants, are typically used in nonaqueous lithium batteries comprising a positive electrode, a negative electrode, and the nonaqueous electrolyte solution. A nonaqueous lithium battery can be obtained by injecting a nonaqueous electrolyte solution between the negative electrode and the positive electrode optionally having a separator therebetween.

The following examples are presented for purposes of illustration, and are not intended to impose limitations on the scope of this invention.

In Example 1, a modified horizontal UL-94 test was performed. This modified horizontal UL-94 test is quite similar to known, published horizontal UL-94 tests. See in this regard, e.g., Otsuki, M. et al. “Flame-Retardant Additives for Lithium-Ion Batteries.” Lithium-Ion Batteries. Ed. M. Yoshio et al. New York, Springer, 2009, 275-289. The modified UL-94 test was as follows:
Wicks were cut from round fiberglass wick, and cut edges were made smooth, and then dust and particles were removed from the wick surface. The wicks were dried for 24 hours at 15° C. prior to testing. Wicks were 5±0.1 inch (12.7±0.25 cm) long.
Each specimen to be tested was prepared in a dry box in a 4 oz. (120 mL) glass jar, by combining the desired amount of flame retardant and, when present, electrochemical additive, with the desired amount of the electrolyte solution, e.g., 20 wt % of the brominated flame retardant and 80 wt % of the electrolyte solution were combined to form the electrolyte solution containing the flame retardant. Prior to combination with the flame retardant, the electrolyte solution contained 1.2 M LiPF₆ in ethylene carbonate/ethyl methyl carbonate (wt ratio 3:7). Each wick was soaked in the electrolyte solution for 30 minutes.
Each specimen was removed from the electrolyte solution and held over the electrolyte solution until no dripping occurred, and then placed in a 4 oz. (120 mL) glass jar; the cap was closed to prevent electrolyte solution from evaporating.
The burner was ignited and adjusted to produce a blue flame 20±1 mm high.
A specimen was removed from its 4 oz. (120 mL) glass jar, and the specimen was placed on a metal support fixture in a horizontal position, secured at one end of the wick.
If an exhaust fan was running, it was shut off for the test.
The flame was at an angle of 45±2 degrees to the horizontal wick. One way to accomplish this when the burner had a burner tube was to incline the central axis of the burner tube toward an end of the specimen at an angle of 45±2 degrees from the horizontal.
The flame was applied to the free end of the specimen for 30±1 seconds without changing its position; the burner was removed after 30±1 seconds, or as soon as the combustion front on the specimen reached the 1 inch (2.54 cm) mark.
If the specimen continued to burn after removal of the test flame, the time in seconds was recorded, for either the flame to extinguish or for the combustion front (flame) to travel from the 1 inch (2.54 cm) mark to the 4 inch (10.16 cm) mark.

A specimen was considered to be “not flammable” if the flame extinguished when the burner was removed. A specimen was considered to be “flame retardant” if the flame extinguished before reaching the 1 inch (2.54 cm) mark. A specimen was considered to be “self-extinguishing” if the flame went out before reaching the 4 inch (10.16 cm) mark.

Each modified horizontal UL-94 test result reported below is the average of three runs.

### EXAMPLE 1

Various nonaqueous electrolyte solutions containing different oxygen-containing brominated flame retardants, prepared as described above, were subjected to the modified UL-94 test described above. Results are summarized in Table 1 below; as noted above, the reported numbers are an average value from three runs.

TABLE 1

| | Flame retardant | Bromine | | Time to | |
|---|---|---|---|---|---|
| Flame retardant | wt % in soln. | wt % in soln. | Result | extinguish | |
| 2-bromothiophene¹ | 25 | 12.2 | fail¹ | 189 | s |
| 2-bromothiophene¹ | 30 | 14.6 | self-extinguish¹ | 106 | s |
| 2,3-dibromothiophene | 20 | 13.2 | flame retardant | 22 | s |
| 2,5-dibromothiophene¹ | 15 | 9.9 | fail¹ | 151 | s |
| 2,5-dibromothiophene | 20 | 13.2 | flame retardant | 21 | s |
| 2-bromothiazole | 25 | 12.2 | flame retardant | 23 | s |
| 2,5-dibromothiazole^{1,2} | 16 | 10.5 | self-extinguish¹ | 108 | s |
| Ethyl 2,5-dibromothiophene- | 20 | 10.1 | flame retardant | 14 | s |
| 3-carboxylate | | | | | |
| Ethyl 2,5-dibromothiophene- | 33 | 16.8 | flame retardant | 4 | s |
| 3-carboxylate | | | | | |
| Ethyl 4,5-dibromothiophene- | 20 | 10.1 | flame retardant | 19 | s |
| 3-carboxylate | | | | | |

¹Comparative run.
²Close to its solubility limit.

### Example 2

Tests of some flame retardants in coin cells were also carried out. Coin cells were assembled using nonaqueous electrolyte solutions containing the desired amount of flame retardant. The coin cells were then subjected to electrochemical cycling of CCCV charging to 4.2 V at C/5, with a current cutoff of C/50 in the CV portion, and CC discharge at C/5 to 3.0 V.

One sample was a nonaqueous electrolyte solution without a flame retardant, and contained 1.2 M LiPF₆ in ethylene carbonate/ethyl methyl carbonate (wt ratio 3:7). The rest of the samples contained the desired amount of flame retardant in the electrolyte solution.

Results are summarized in Table 2 below; the error range in the Coulombic efficiencies is about ±0.5% to about ±1.0%.

TABLE 2

| | | | Coulombic | | Discharge specific | |
|---|---|---|---|---|---|---|
| | Flame | | efficiency | | capacity, mAh/g | |
| | retardant | Bromine | 1st | 10th | 1st | 10th |
| Chemical Name | in soln. | in soln. | cycle | cycle | cycle | cycle |
| Electrolyte soln.¹ | 0 | 0 | 81.8% | 99.6% | 149.8 | 152.5 |
| 2,5-dibromothiophene² | 8 wt % | 5.3 wt % | 58% | 98.3% | 139.8 | 148.9 |
| 2,5-dibromothiophene² + | 8 wt % | 5.3 wt % | 81.1% | 99.8% | 150.6 | 157.3 |
| LiDFOB³ (2 wt %) + | | | | | | |
| succinonitrile (1 wt %) | | | | | | |
| 2,3-dibromothiophene² | 8 wt % | 5.3 wt % | 76.1% | 96.9% | 138.5 | 112.6 |
| 2,3-dibromothiophene² + | 8 wt % | 5.3 wt % | 81.8% | 99.9% | 152.0 | 160.1 |
| LiDFOB³ (2 wt %) + | | | | | | |
| succinonitrile (1 wt %) | | | | | | |
| 2-bromothiazole² | 8 wt % | 3.9 wt % | 35.4% | 90.2% | 118.7 | 103.7 |

¹Comparative run.
²Data is from single best-performing cell.
³LiDFOB is lithium di(fluoro)(oxalato)borate.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A nonaqueous electrolyte solution for a lithium battery, which solution comprises
i) a liquid electrolyte medium;
ii) a lithium-containing salt; and
iii) at least one brominated flame retardant selected from
a) a brominated thiophene having two or more bromine atoms bound to the same thiophene ring, in which
the brominated thiophene has one or two substituents on the thiophene ring in addition to the bromine atoms, which substituents are selected from ether groups, ester groups, or carbonate groups, with the proviso that the ether oxygen atom is not bound directly to the thiophene ring, and which brominated thiophene has about six to about twelve carbon atoms, or
the brominated thiophene is 2,3-dibromothiophene, 2,4-dibromothiophene, 2,5-dibromothiophene, 3,4-dibromothiophene, 2,3,4-tribromothiophene, or 2,3,5-tribromothiophene,
b) a brominated thiazole having one or two bromine atoms bound to the thiazole ring, wherein when the brominated thiazole has two bromine atoms bound to the thiazole ring and the bromine atoms are in the 2 and 5 positions on the ring, a carbon atom of the thiazole ring has an oxygen-containing substituent bound thereto, and
c) a brominated thiadiazole having one bromine atom bound to the thiadiazole ring and an oxygen-containing substituent bound to a carbon atom of the thiadiazole ring.

2. A solution as in claim 1 wherein the brominated flame retardant is
I) a brominated thiophene which has four to about twelve carbon atoms, two to about four bromine atoms bound to the thiophene ring, and/or a bromine content of about 40 wt % or more relative to the total weight of the brominated flame retardant;
a brominated thiazole which contains three to about twelve carbon atoms and has one bromine atom bound to the thiazole ring;
a brominated thiazole which contains four to about twelve carbon atoms and has two bromine atoms bound to the thiazole ring, and/or has a bromine content of about 30 wt % or more relative to the total weight of the brominated flame retardant; or
a brominated thiadiazole which has three to about twelve carbon atoms and/or a bromine content of about 22 wt % or more, relative to the total weight of the brominated flame retardant; or
II) a brominated thiophene which has four to about ten carbon atoms, two to about three bromine atoms bound to the thiophene ring, and a bromine content of about 45 wt % or more relative to the total weight of the brominated flame retardant;
a brominated thiazole which contains three to about ten carbon atoms and has one bromine atom bound to the thiazole ring, and a bromine content of about 30 wt % or more relative to the total weight of the brominated flame retardant; or
a brominated thiazole which contains four to about ten carbon atoms and has two bromine atoms bound to the thiazole ring, and a bromine content of about 30 wt % or more relative to the total weight of the brominated flame retardant; or
a brominated thiadiazole which has three to about ten carbon atoms, two bromine atoms bound to the thiazole ring, and a bromine content of about 22 wt % or more, relative to the total weight of the brominated flame retardant.

3. (canceled)

4. A solution as in claim 1 wherein the brominated flame retardant is
a brominated thiazole wherein the oxygen-containing substituent is selected from hydrocarbyloxy groups and ether groups; or
a brominated thiadiazole which has which has a bromine content of about 22 wt % to about 45 wt %, relative to the total weight of the brominated flame retardant.

5. A solution as in claim 1 wherein the brominated thiazole is a 1,3-thiazole, or wherein the brominated thiadiazole is a 1,3,4-thiadiazole.

6. A solution as in claim 5 wherein the 1,3-thiazole is 2-bromothiazole, 4-bromothiazole, 5-bromothiazole, 2,4-dibromothiazole, 4,5-dibromothiazole, 4,5-dibromo-2-methoxythiazole, or 4,5-dibromo-2-(2-methoxyethoxy)thiazole, or wherein the 1,3,4-thiadiazole is 2-bromo-5-methoxy-1,3,4-thiadiazole, 2-bromo-5-(2-methoxyethoxy)-1,3,4-thiadiazole, or 2-bromo-5-(2-ethoxyethoxy)-1,3,4-thiadiazole.

7-9. (canceled)

10. A solution as in claim 1 wherein the brominated flame retardant is
i) a brominated thiophene which has an ether group as substituent on the thiophene ring, wherein the ether group has a portion between the thiophene ring and the ether oxygen atom, which portion is a saturated hydrocarbylene group having one to about four carbon atoms, and wherein the other group attached to the ether oxygen atom is a saturated hydrocarbyl group having one to about four carbon atoms; or
ii) a brominated flame retardant is a brominated thiophene which has an ester group as substituent on the thiophene ring, wherein the carbonyl moiety of the ester group is bound directly to the thiophene ring, and wherein the other portion of the ester group is a hydrocarbyl group having one to about four carbon atoms; or
iii) a brominated thiophene which has a carbonate group as substituent on the thiophene ring, wherein an oxygen atom of the carbonate group can be bound directly to the thiophene ring, or not bound directly to the thiophene ring, and wherein the group attached to the other carbonate oxygen atom is either a hydrocarbyl group having one to about four carbon atoms or an ether group having three to about six carbon atoms, and one to three oxygen atoms.

11. A solution as in claim 10 wherein
in i) the brominated flame retardant is propyl 1,1-dimethyl-2-[4-(2,3,5-tribromothiophene)]ethyl ether;
in ii) the brominated flame retardant is methyl 2,5-dibromothiophene-3-carboxylate, ethyl 2,5-dibromothiophene-3-carboxylate, methyl 4,5-dibromothiophene-2-carboxylate, ethyl 4,5-dibromothiophene-2-carboxylate, ethyl 4,5-dibromothiophene-3-carboxylate, dimethyl 3,4-dibromothiophene-2,5-dicarboxylate, or diethyl 3,4-dibromothiophene-2,5-dicarboxylate;
in iii) the carbonate group is not bound to the thiophene ring via an oxygen atom of the carbonate group, and the portion of the carbonate group between the thiophene ring and the carbonate oxygen atom is a saturated hydrocarbylene group having one to about four carbon atoms; or
in iii) the brominated flame retardant is ethyl 4-(2,3,5-tribromothiophene) carbonate or methyl 1,1-dimethyl-2-[4-(2,3,5-tribromothiophene)]ethyl carbonate.

12-16. (canceled)

17. A solution as in claim 1 wherein the brominated flame retardant is in an amount of about 12 wt % or more bromine relative to the total weight of the solution.

18. A solution as in claim 1 wherein the liquid electrolyte medium is ethylene carbonate, ethyl methyl carbonate, or a mixture thereof, and/or wherein the lithium-containing salt is lithium hexafluorophosphate, lithium di(fluoro)(oxoxalato)borate, or lithium bis(oxalato)borate.

19. A solution as in claim 1 further comprising at least one electrochemical additive selected from:
I)
a) unsaturated cyclic carbonates containing three to about six carbon atoms,
b) fluorine-containing saturated cyclic carbonates containing three to about five carbon atoms and one to about four fluorine atoms,
c) tris(trihydrocarbylsilyl) phosphites containing three to about nine carbon atoms,
d) trihydrocarbyl phosphates containing three to about twelve carbon atoms,
e) cyclic sultones containing three to about eight carbon atoms,
f) saturated cyclic hydrocarbyl sulfites having a 5-membered or 6-membered ring and containing two to about six carbon atoms,
g) saturated cyclic hydrocarbyl sulfates having a 5-membered or 6-membered ring and containing two to about six carbon atoms,
h) cyclic dioxadithio polyoxide compounds having a 6-membered, 7-membered, or 8-membered ring and containing two to about six carbon atoms,
i) another lithium-containing salt, and
j) mixtures of any two or more of the foregoing; or
II)
a) unsaturated cyclic carbonates containing three to about four carbon atoms,
b) fluorine-containing saturated cyclic carbonates containing three to about four carbon atoms and one to about two fluorine atoms,
c) tris(trihydrocarbylsilyl) phosphites containing three to about six carbon atoms,
d) trihydrocarbyl phosphates containing three to about nine carbon atoms,
e) cyclic sultones containing three to about four carbon atoms,
f) saturated cyclic hydrocarbyl sulfites having a 5-membered ring and containing two to about four carbon atoms,
g) saturated cyclic hydrocarbyl sulfates having a 5-membered ring and containing two to about four carbon atoms,
h) cyclic dioxadithio polyoxide compounds having a 6-membered or 7-membered ring and containing two to about four carbon atoms,
i) another lithium-containing salt, and
j) mixtures of any two or more of the foregoing.

20. (canceled)

21. A solution as in claim 19 wherein the electrochemical additive is selected from:
a) an unsaturated cyclic carbonate in an amount of about 0.5 wt % to about 12 wt %, relative to the total weight of the nonaqueous electrolyte solution,
b) a fluorine-containing saturated cyclic carbonate in an amount of about 0.5 wt % to about 8 wt %, relative to the total weight of the nonaqueous electrolyte solution,
c) a tris(trihydrocarbylsilyl) phosphite in an amount of about 0.1 wt % to about 5 wt %, relative to the total weight of the nonaqueous electrolyte solution,
d) a trihydrocarbyl phosphate in an amount of about 0.5 wt % to about 5 wt %, relative to the total weight of the nonaqueous electrolyte solution,
e) a cyclic sultone in an amount of about 0.25 wt % to about 5 wt %, relative to the total weight of the nonaqueous electrolyte solution,
f) a saturated cyclic hydrocarbyl sulfite in an amount of about 0.5 wt % to about 5 wt %, relative to the total weight of the nonaqueous electrolyte solution,
g) a saturated cyclic hydrocarbyl sulfate in an amount of about 0.25 wt % to about 5 wt %, relative to the total weight of the nonaqueous electrolyte solution,
h) a cyclic dioxadithio polyoxide compound in an amount of about 0.5 wt % to about 5 wt %, relative to the total weight of the nonaqueous electrolyte solution,
i) another lithium-containing salt in an amount of about 0.5 wt % to about 5 wt %, relative to the total weight of the nonaqueous electrolyte solution, and
j) mixtures of any two or more of the foregoing.

22. A solution as in claim 17 wherein each electrochemical additive is not used with other electrochemical additives.

23. A solution as in claim 17 wherein the solution further comprises a nitrile compound, optionally wherein the nitrile compound is succinonitrile, or wherein the solution further comprises a nitrile compound and another lithium-containing salt, optionally wherein the nitrile compound is succinonitrile and the lithium-containing salt is lithium di(fluoro)(oxalato)borate.

24-26. (canceled)

27. A nonaqueous lithium battery comprising a positive electrode, a negative electrode, and a nonaqueous electrolyte solution as in claim 1.

28. A nonaqueous electrolyte solution for a lithium battery as in claim 1, in which the solution comprises
at least one brominated flame retardant is selected from the group consisting of 2,3-dibromothiophene, 2,4-dibromothiophene, 2,5-dibromothiophene, 3,4-dibromothiophene, 2,3,4-tribromothiophene, 2,3,5-tribromothiophene, propyl 1,1-dimethyl-2-[4-(2,3,5-tribromothiophene)]ethyl ether, ethyl 4-(2,3,5-tribromothiophene) carbonate, methyl 1,1-dimethyl-2-[4-(2,3,5-tribromothiophene)]ethyl carbonate, methyl 2,5-dibromothiophene-3-carboxylate, ethyl 2,5-dibromothiophene-3-carboxylate, methyl 4,5-dibromothiophene-2-carboxylate, ethyl 4,5-dibromothiophene-2-carboxylate, ethyl 4,5-dibromothiophene-3-carboxylate, dimethyl 3,4-dibromothiophene-2,5-dicarboxylate, diethyl 3,4-dibromothiophene-2,5-dicarboxylate, 2-bromothiazole, 4-bromothiazole, 5-bromothiazole, 2,4-dibromothiazole, 4,5-dibromothiazole, 4,5-dibromo-2-methoxythiazole, 4,5-dibromo-2-(2-methoxyethoxy)thiazole, 2-bromo-5-methoxy-1,3,4-thiadiazole, 2-bromo-5-(2-methoxyethoxy)-1,3,4-thiadiazole, and 2-bromo-5-(2-ethoxyethoxy)-1,3,4-thiadiazole.

29. A solution as in claim 28 wherein the brominated flame retardant is 2,5-dibromothiophene.

30. A solution as in claim 28 wherein the brominated flame retardant is 2,3-dibromothiophene.

31. A solution as claim 30 wherein the brominated flame retardant is in an amount of about 13 wt % or more bromine relative to the total weight of the solution.

32. A solution as in claim 28 wherein the brominated flame retardant is 2-bromothiazole, 4-bromothiazole, 5-bromothiazole, 2,4-dibromothiazole, 4,5-dibromothiazole, 4,5-dibromo-2-methoxythiazole or 4,5-dibromo-2-(2-methoxyethoxy)thiazole.

33. A solution as in claim 29 wherein the brominated flame retardant is in an amount of about 12 wt % or more bromine relative to the total weight of the solution.

34. A solution as in claim 28 wherein the liquid electrolyte medium is ethylene carbonate, ethyl methyl carbonate, or a mixture thereof, and/or wherein the lithium-containing salt is lithium hexafluorophosphate, lithium di(fluoro)(oxalato)borate, or lithium bis(oxalato)borate.

35. A solution as in claim 28 wherein the solution further comprises a nitrile compound or a nitrile compound and another lithium-containing salt, optionally wherein the nitrile compound is succinonitrile or wherein the nitrile compound is succinonitrile and the lithium-containing salt is lithium di(fluoro)(oxalato)borate.

36. (canceled)

37. A nonaqueous lithium battery comprising a positive electrode, a negative electrode, and a nonaqueous electrolyte solution as in claim 27.

38. A process for producing a nonaqueous electrolyte solution for a lithium battery, which process comprises combining components comprising:
i) a liquid electrolyte medium;
ii) a lithium-containing salt; and
iii) at least one brominated flame retardant comprising
a) a brominated thiophene having two or more bromine atoms bound to the same thiophene ring, in which
the brominated thiophene has one or two substituents on the thiophene ring in addition to the bromine atoms, which substituents are selected from ether groups, ester groups, or carbonate groups, with the proviso that the ether oxygen atom is not bound directly to the thiophene ring, and which brominated thiophene has about six to about twelve carbon atoms, or
the brominated thiophene is 2,3-dibromothiophene, 2,4-dibromothiophene, 2,5-dibromothiophene, 3,4-dibromothiophene, 2,3,4-tribromothiophene, or 2,3,5-tribromothiophene,
b) a brominated thiazole having one or two bromine atoms bound to the thiazole ring, wherein when the brominated thiazole has two bromine atoms bound to the thiazole ring and the bromine atoms are in the 2 and 5 positions on the ring, a carbon atom of the thiazole ring has an oxygen-containing substituent bound thereto, and
c) a brominated thiadiazole having one bromine atom bound to the thiadiazole ring and an oxygen-containing substituent bound to a carbon atom of the thiadiazole ring.

39. A process as in claim 38 wherein the components further comprise at least one electrochemical additive selected from:
a) unsaturated cyclic carbonates containing three to about six carbon atoms,
b) fluorine-containing saturated cyclic carbonates containing three to about five carbon atoms and one to about four fluorine atoms,
c) tris(trihydrocarbylsilyl) phosphites containing three to about nine carbon atoms,
d) trihydrocarbyl phosphates containing three to about twelve carbon atoms,
e) cyclic sultones containing three to about eight carbon atoms,
f) saturated cyclic hydrocarbyl sulfites having a 5-membered or 6-membered ring and containing two to about six carbon atoms,
g) saturated cyclic hydrocarbyl sulfates having a 5-membered or 6-membered ring and containing two to about six carbon atoms,
h) cyclic dioxadithio polyoxide compounds having a 6-membered, 7-membered, or 8-membered ring and containing two to about six carbon atoms,
i) another lithium-containing salt, and
j) mixtures of any two or more of the foregoing; and/or
wherein the components further comprise a nitrile compound or a nitrile compound and another lithium-containing salt, optionally wherein the nitrile compound is succinonitrile or wherein the nitrile compound is succinonitrile and the lithium-containing salt is lithium di(fluoro)(oxalato)borate.

40-41. (canceled)

42. A process for producing a nonaqueous electrolyte solution for a lithium battery as in claim 38, in which the
at least one brominated flame retardant is selected from the group consisting of 2,3-dibromothiophene, 2,4-dibromothiophene, 2,5-dibromothiophene, 3,4-dibromothiophene, 2,3,4-tribromothiophene, 2,3,5-tribromothiophene, propyl 1,1-dimethyl-2-[4-(2,3,5-tribromothiophene)]ethyl ether, ethyl 4-(2,3,5-tribromothiophene) carbonate, methyl 1,1-dimethyl-2-[4-(2,3,5-tribromothiophene)]ethyl carbonate, methyl 2,5-dibromothiophene-3-carboxylate, ethyl 2,5-dibromothiophene-3-carboxylate, methyl 4,5-dibromothiophene-2-carboxylate, ethyl 4,5-dibromothiophene-2-carboxylate, ethyl 4,5-dibromothiophene-3-carboxylate, dimethyl 3,4-dibromothiophene-2,5-dicarboxylate, diethyl 3,4-dibromothiophene-2,5-dicarboxylate, 2-bromothiazole, 4-bromothiazole, 5-bromothiazole, 2,4-dibromothiazole, 4,5-dibromothiazole, 4,5-dibromo-2-methoxythiazole, 4,5-dibromo-2-(2-methoxyethoxy)thiazole, 2-bromo-5-methoxy-1,3,4-thiadiazole, 2-bromo-5-(2-methoxyethoxy)-1,3,4-thiadiazole, and 2-bromo-5-(2-ethoxyethoxy)-1,3,4-thiadiazole.

43. A process as in claim 42 wherein the components further comprise:
at least one electrochemical additive selected from vinylene carbonate, 4-fluoro-ethylene carbonate, tris(trimethylsilyl)phosphite, triallyl phosphate, 1,3-propane sultone, 1,3-propene sultone, ethylene sulfite, 1,3,2-dioxathiolane 2,2-dioxide, 1,5,2,4-dioxadithiane 2,2,4,4-tetroxide, lithium di(fluoro)(oxalato)borate, lithium bis(oxalato)borate, and mixtures of any two or more of these; and/or
a nitrile compound, optionally wherein the nitrile compound is succinonitrile; or wherein the components further comprise a nitrile compound and another lithium-containing salt, optionally wherein the nitrile compound is succinonitrile and the lithium-containing salt is lithium di(fluoro)(oxalato)borate.

44-46. (canceled)

47. A process as in claim 42 wherein the brominated flame retardant is 2,3-dibromothiophene or 2,5-dibromothiophene.
